(19) United States
(12) Patent Application Publication
(10) Pub. No.: US 2018/0299935 A1
(43) Pub. Date: Oct. 18, 2018

(54) MEMORY DEVICE AND DATA STORAGE DEVICE INCLUDING THE SAME

(71) Applicant: SK hynix Inc., Icheon-si Gyeonggi-do (KR)

(72) Inventors: Byoung Kwan JEONG, Icheon-si Gyeonggi-do (KR); Beom Ju SHIN, Suwon-si Gyeonggi-do (KR); Keun Hyung KIM, Icheon-si Gyeonggi-do (KR)

(73) Assignee: SK hynix Inc., Icheon-si Gyeonggi-do (KR)

(21) Appl. No.: 15/826,097

(22) Filed: Nov. 29, 2017

(30) Foreign Application Priority Data
Apr. 13, 2017 (KR) 10-2017-0048091

(51) Int. Cl. G06F 1/20; G06F 3/06

(52) U.S. Cl. CPC G06F 1/206; G06F 3/061; G06F 3/068; G06F 3/0659

(57) ABSTRACT

A memory device may include a memory region, and a control unit for performing an internal operation on the memory region in response to a command received from an external device, and in a wait state in connection with the performance of the internal operation, which depends on the internal operation.

### CROSS-REFERENCES TO RELATED APPLICATION

The present application claims priority under 35 U.S.C. § 119(a) to Korean application number 10-2017-0048091, filed on Apr. 13, 2017, in the Korean Intellectual Property Office, which is incorporated herein by reference in its entirety.

### BACKGROUND

### 1. Technical Field

Various embodiments generally relate to a memory device and a data storage device including the same.

### 2. Related Art

Data storage devices store data provided by an external device in response to a write request. Data storage devices may also provide stored data to an external device in response to a read request. Examples of external devices that use data storage devices include computers, digital cameras, cellular phones and the like. Data storage devices may be embedded in an external device during manufacturing of the external devices or may be fabricated separately and then connected afterwards to an external device.

### SUMMARY

In an embodiment, a memory device may include: a memory region; and a control unit suitable for performing an internal operation on the memory region in response to a command received from an external device, and in a wait state in connection with the performance of the internal operation, which depends on the internal operation.

In an embodiment, a memory device may include: a memory region; and a control unit suitable for receiving a command for controlling the memory region from an external device, transmitting a busy-state ready/busy signal to the external device in response to the command, and having a wait state depending on an internal temperature. The control unit may retain the ready/busy signal in the busy state while in the wait state.

In an embodiment, a memory device may include: a memory region; and a control unit suitable for performing an internal operation on the memory region in response to a command received from an external device, and delaying reporting a completion of the internal operation to the external device, depending on an internal operation.

In an embodiment, a data storage device may include: a memory device including a temperature sensor; and a controller suitable for setting a maximum temperature in the memory device, and transmitting a command to the memory device. The memory device may perform an internal operation in response to the command, and have a wait state in connection with the performance of the internal operation, depending on the maximum temperature and an internal temperature acquired from the temperature sensor.

In an embodiment, a data storage device may include: a memory device including a temperature sensor; and a controller suitable for setting a maximum temperature in the memory device, and transmitting a command to the memory device. The memory device may transmit a busy-state ready/busy signal to the controller in response to the command, have a wait state depending on an internal temperature acquired from the temperature sensor, and retain the ready/busy signal in the busy state while in the wait state.

In an embodiment, a data storage device may include: a memory device including a temperature sensor; and a controller suitable for setting a maximum temperature in the memory device, and transmitting a command to the memory device. The memory device may perform an internal operation in response to the command, and delay reporting completion of the internal operation to the controller, depending on an internal temperature acquired from the temperature sensor.

### BRIEF DESCRIPTION OF THE DRAWINGS

The above and other features and advantages of the present disclosure will become more apparent to those skilled in the art to which the present disclosure belongs by describing various embodiments thereof with reference to the attached drawings in which:

FIG. 1 is a block diagram illustrating a data storage device including a memory device in accordance with an embodiment.

FIGS. 2A to 2C are diagrams for describing a method in which a wait state control unit of FIG. 1 has a wait state in relation to performance of an internal operation.

FIGS. 3A to 3C are diagrams for describing a method in which the wait state control unit of FIG. 1 has a wait state while performing an internal operation.

FIG. 4 is a flowchart illustrating an operating method of the memory device of FIG. 1.

FIG. 5 is a flowchart illustrating an operating method of the memory device of FIG. 1.

FIG. 6 is a flowchart illustrating an operating method of the memory device of FIG. 1.

FIG. 7 is a flowchart illustrating an operating method of the memory device of FIG. 1.

FIG. 8 is a flowchart illustrating an operating method of the memory device of FIG. 1.

### DETAILED DESCRIPTION

Hereinafter, a data storage device and an operating method thereof according to the present disclosure will be described with reference to the accompanying drawings through exemplary embodiments of the present disclosure. The present disclosure may, however, be embodied in different forms and should not be construed as being limited to the embodiments set forth herein. Rather, these embodiments are provided to describe the present disclosure in detail to the extent that a person skilled in the art to which the disclosure pertains can enforce the technical concepts of the present disclosure.

It is to be understood that embodiments of the present disclosure are not limited to the particulars shown in the drawings, that the drawings are not necessarily to scale, and, in some instances, proportions may have been exaggerated in order to more clearly depict certain features of the disclosure. While particular terminology is used, it is to be appreciated that the terminology used is for describing particular embodiments only and is not intended to limit the scope of the present disclosure.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The phrase “at least one of . . . and . . . ,” when used herein with a list of items, means a single item from the list or any combination of items in the list. For example, “at least one of A, B, and C” means, only A, or only B, or only C, or any combination of A, B, and C.

The term “or” as used herein means either one of two or more alternatives but not both nor any combinations thereof.

As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present disclosure pertains in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

It is also noted, that in some instances, as would be apparent to those skilled in the relevant art, an element also referred to as a feature described in connection with one embodiment may be used singly or in combination with other elements of another embodiment, unless specifically indicated otherwise.

Hereinafter, the various embodiments of the present disclosure will be described in detail with reference to the attached drawings.

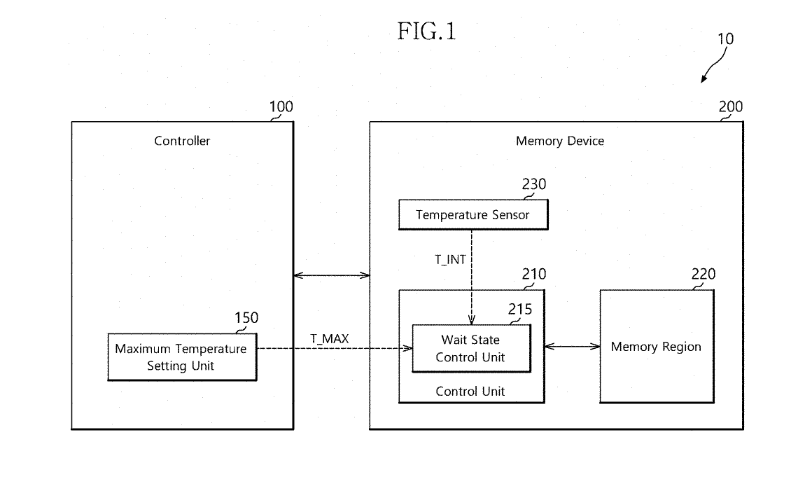

FIG. 1 is a block diagram illustrating a data storage device 10 including a memory device 200 in accordance with an embodiment.

The data storage device 10 may store data and provide the stored data to a host device, according to control of the host device.

The data storage device 10 may be in the form of a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), a Solid State Drive (SSD), and the like.

The data storage device 10 may include a controller 100 and the memory device 200.

The controller 100 (i.e., an external device) may control operations of the data storage device 10. The controller 100 may store data in the memory device 200 in response to a write request transmitted from the host device, or read data stored in the memory device 200 and transmit the read data to the host device in response to a read request transmitted from the host device.

The controller 100 may include a maximum temperature setting unit 150. The maximum temperature setting unit 150 may set a maximum temperature T_MAX in a wait state control unit 215 of the memory device 200. As described later, the wait state control unit 215 may compare the maximum temperature T_MAX to an internal temperature T_INT of the memory device 200, in order for the memory device 200 to decide whether to enter a wait state to wait for the temperature of the memory device 200 to go down. That is, the maximum temperature T_MAX may be related to the performance of the memory device 200.

Specifically, when the maximum temperature setting unit 150 sets the maximum temperature T_MAX to a higher value, the memory device 200 may have a shorter wait state at a lower frequency. As a result, the memory device 200 may operate at higher speed. On the other hand, when the maximum temperature setting unit 150 sets the maximum temperature T_MAX to a lower value, the memory device 200 may have a longer wait state at a higher frequency. As a result, the memory device 200 may operate at lower speed.

The internal temperature of the memory device 200 may have an influence on the reliability of the memory device 200. In particular, when the internal temperature is high, the memory device 200 may operate abnormally. Thus, the internal temperature of the memory device 200 needs to be controlled so that the internal temperature does not rise to a high temperature.

Therefore, the maximum temperature setting unit 150 may set the maximum temperature T_MAX in consideration of the performance and reliability of the memory device 200. The maximum temperature setting unit 150 may have no restrictions as to the time that the maximum temperature T_MAX is set or the number of times the maximum temperature T_MAX is set. Furthermore, the maximum temperature setting unit 150 may set the maximum temperature T_MAX based on various conditions. For example, when the operation failure rate or error rate of the memory device 200 increases, the maximum temperature setting unit 150 may set the maximum temperature T_MAX to a lower temperature in order to slow the performance of the memory device 200. For example, when the host device requests a predetermined level of performance of the memory device 200, the maximum temperature setting unit 150 may set a proper maximum temperature T_MAX in order to provide the requested performance. For example, the maximum temperature setting unit 150 may analyze and estimate a work load from the host device, and then set the maximum temperature T_MAX so that the memory device 200 has a predetermined level of performance.

In short, according to the maximum temperature T_MAX set by the controller 100, the memory device 200 can provide high reliability and optimal performance by monitoring its own internal temperature, and the controller 100 may impose no burden in monitoring the memory device 200.

The memory device 200 may perform various internal operations, for example, a write operation, read operation, and erase operation on a memory region 220, according to control of the controller 100. At this time, in connection with an internal operation, the memory device 200 may acquire its internal temperature T_INT through a temperature sensor 230 and compare the internal temperature T_INT and the maximum temperature T_MAX, to determine whether to enter a wait state. Because the memory device 200 adjusts its operation performance according to the internal temperature T_INT, the controller 100 does not need to monitor the temperature of the memory device 200.

The memory device 200 may include a control unit 210, the memory region 220, and the temperature sensor 230.

The control unit 210 may control overall operations of the memory device 200. According to control of the controller 100, the control unit 210 may perform a variety of other internal operations required for operation of the memory device 200, in addition to the write operation, read operation, and erase operation in the memory region 220.

The control unit 210 may include the wait state control unit 215. When a command indicating an internal operation is transmitted from the controller 100 to the memory device 200, the wait state control unit 215 may decide whether to be in a wait state in connection with performance of an internal operation, depending on the maximum temperature T_MAX and the internal temperature T_INT of the memory device 200 acquired from the temperature sensor 230. Accordingly, the control unit 210 may be in a wait state in connection with performance of the internal operation, where the wait state depends on the internal operation.

Specifically, when the internal temperature T_INT is less than the maximum temperature T_MAX, the wait state control unit 215 may not be in a wait state. On the other hand, when the internal temperature T_INT is higher than the maximum temperature T_MAX, the wait state control unit 215 may be in a wait state.

The wait state control unit 215 may receive a command from the controller 100 and may be in a wait state one or more of before, during, and after the wait control unit 215 performs an internal operation depending on the internal temperature T_INT of the memory device 200. The wait state may be maintained for a predetermined time. When the wait state is maintained, the control unit 210 may delay the start of the internal operation, hold the internal operation which was going to be performed, and delay reporting completion of the internal operation to the controller 100.

In another embodiment, when the internal operation includes one or more sub internal operations, the wait state control unit 215 may be in a wait state between consecutive sub internal operations performed in response to the command received from the controller 100, depending on the internal temperature T_INT.

In another embodiment, the wait state control unit 215 may acquire the internal temperature T_INT and enter a wait state, with a time difference set therebetween. That is, because the operation of accessing the temperature sensor 230 to acquire the internal temperature T_INT requires time, the wait state control unit 215 may not acquire the internal temperature T_INT in real time, but may acquire the internal temperature T_INT in advance and separately store the acquired temperature. For example, the wait state control unit 215 may receive a command from the controller 100, acquire and store the internal temperature T_INT before an internal operation is performed, and enter the wait state depending on the stored internal temperature T_INT after at least part of the internal operation is performed. As such, the method in which the wait state control unit 215 has a wait state depending on the internal temperature T_INT acquired in advance and the method in the wait state control unit 215 acquires the internal temperature T_INT in real time and immediately has a wait state may be substantially the same as each other, except that the time that the internal temperature T_INT is acquired may differ between these two methods.

In another embodiment, the wait state control unit 215 may acquire the internal temperature T_INT in real time at each predetermined cycle, and compare the internal temperature T_INT to the maximum temperature T_MAX, thereby being in a wait state.

In another embodiment, the wait state control unit 215 may be in a wait state for a predetermined wait time, and then reacquire the internal temperature T_INT, thereby repeatedly being in a wait state.

In another embodiment, the wait state control unit 215 may be in a wait state only for a selected internal operation among various internal operations of the memory device 200, depending on the internal temperature T_INT. For example, the wait state control unit 215 may not be in a wait state for an internal operation which needs to be rapidly processed. Also, the wait state control unit 215 may not be in a wait state for a simple internal operation which can be rapidly processed and does not significantly raise the internal temperature T_INT.

The memory region 220 may store data. As described later, the memory region 220 may include a plurality of nonvolatile or volatile memory cells, depending on whether the memory device 200 has a nonvolatile or volatile memory.

The temperature sensor 230 may sense the internal temperature T_INT of the memory device 200, and provide the internal temperature T_INT to the wait state control unit 215 according to a request of the wait state control unit 215.

The memory device 200 may include a nonvolatile memory device or volatile memory device. The nonvolatile memory device may include a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

FIG. 1 illustrates that the data storage device 10 of FIG. 1 includes one memory device 200, but the number of memory devices included in the data storage device 10 is not limited thereto.

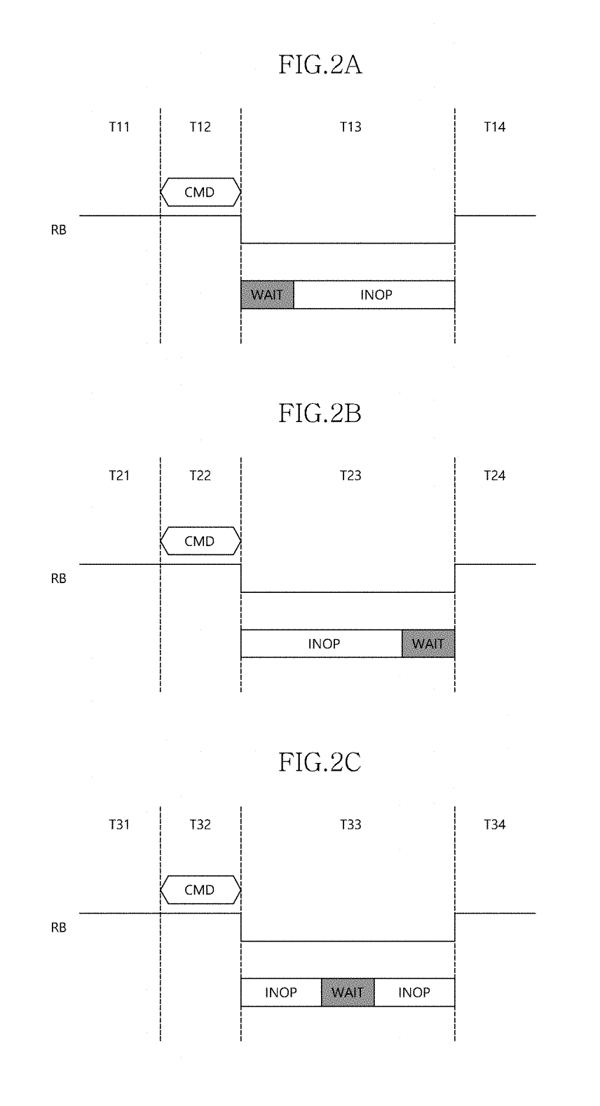

FIGS. 2A to 2C are diagrams for describing a method in which the wait state control unit 215 of FIG. 1 has a wait state WAIT in connection with performance of an internal operation. Referring to FIGS. 2A to 2C, the control unit 210 may be in the wait state WAIT at various times associated with performance of an internal operation.

Referring to FIG. 2A, the control unit 210 may transmit a ready-state or high-level ready/busy signal RB to the controller 100 in section T11. The control unit 210 may report to the controller 100 that the memory device 200 is in an idle state, through the ready-state ready/busy signal RB. In accordance with the present embodiment, however, the unit for informing the controller 100 that the memory device 200 is in an idle state is not limited to the ready/busy signal RB.

In a section T12, the controller 100 may transmit a command CMD to the control unit 210. The command CMD may include the type of an internal operation to be performed by the control unit 210, an address to be accessed in the memory region 220 by the control unit 210, data to be stored in the memory region 220 by the control unit 210, and information required for the control unit 210 to perform the internal operation.

In section T13, the control unit 210 may start the internal operation INOP in response to the command CMD. At this time, the control unit 210 may transmit a busy-state or low-level ready/busy signal RB to the controller 100. The control unit 210 may inform the controller 100 that the memory device 200 is performing the internal operation INOP, through the busy-state ready/busy signal RB. In accordance with the present embodiment, however, the unit for informing the controller 100 that the memory device 200 is performing the internal operation INOP is not limited to the ready/busy signal RB.

At this time, the wait state control unit 215 may be in a wait state WAIT depending on the internal temperature T_INT, before the internal operation INOP corresponding to the command CMD is substantially performed after the command CMD is received by the wait state control unit 215. The wait state control unit 215 may acquire the internal temperature T_INT from the temperature sensor 230 and compare the internal temperature T_INT to the maximum temperature T_MAX, thereby entering the wait state WAIT. The control unit 210 may perform and complete the internal operation INOP when transitioning out of the wait state WAIT.

In section T14, the control unit 210 may convert the ready/busy signal RB into the ready state, and thus inform the controller 100 that the memory device 200 is in an idle state. Then, although not illustrated, the controller 100 may transmit a subsequent command to the control unit 210 in response to the ready-state ready/busy signal RB.

In short, when sensing a high internal temperature T_INT of the memory device 200 before the internal operation INOP is performed, the control unit 210 may perform the internal operation INOP after going through the wait state WAIT, thereby preventing a reduction in reliability of the memory device 200.

Referring to FIG. 2B, operations of the controller 100 and the control unit 210 in sections T21 and T22 may be performed in a similar manner to those in the sections T11 and T12 of FIG. 2A.

In a section T23, the control unit 210 may transmit the busy-state ready/busy signal RB to the controller 100 while in the wait state WAIT in response to the command CMD. Then, the control unit 210 may start and complete the internal operation INOP corresponding to the command CMD. The control unit 210 may retain the ready/busy signal RB in the busy state BUSY while the control unit 210 is in the wait state WAIT.

At this time, the wait state control unit 215 may be in the wait state WAIT depending on the internal temperature T_INT, after substantially completing the internal operation INOP. The wait state control unit 215 may acquire the internal temperature T_INT from the temperature sensor 230 and compare the internal temperature T_INT to the maximum temperature T_MAX, thereby entering the wait state WAIT.

When exiting the wait state WAIT in section T24, the control unit 210 may convert the ready/busy signal RB into the ready state, and thus inform the controller 100 that the memory device 200 is in an idle state.

In short, when the internal temperature T_INT of the memory device 200 rises excessively due to the performance of the internal operation INOP, the control unit 210 can go through the wait state WAIT and then transmit the ready-state ready/busy signal RB to the controller 100, thereby preventing a reduction in reliability of the memory device 200. That is, in order to not receive a subsequent command from the controller 100 even though the internal operation INOP has been substantially completed, the control unit 210 may delay reporting completion of the internal operation INOP to the controller 100 based on the result of comparing the internal temperature T_INT to the maximum temperature T_MAX.

Referring to FIG. 2C, operations of the controller 100 and the control unit 210 in sections T31 and T32 may be performed in a similar manner to those in the sections T11 and T12 of FIG. 2A.

In section T33, the control unit 210 may transmit the busy-state ready/busy signal RB to the controller 100 while in the wait state WAIT in response to the command CMD. Then, the control unit 210 may start the internal operation INOP corresponding to the command CMD.

At this time, the wait state control unit 215 may be in the wait state WAIT depending on the internal temperature T_INT, while the internal operation INOP is performed. The wait state control unit 215 may acquire the internal temperature T_INT from the temperature sensor 230, and compare the internal temperature T_INT to the maximum temperature T_MAX, thereby entering the wait state WAIT. The control unit 210 may resume and complete the internal operation INOP when exiting the wait state WAIT.

In a section T34, the control unit 210 may convert the ready/busy signal RB into the ready state, and thus inform the controller 100 that the memory device 200 is in an idle state.

In short, when the internal temperature T_INT of the memory device 200 rises excessively due to the performance of the internal operation INOP, the control unit 210 can hold the internal operation INOP and then go through the wait state WAIT, thereby preventing a reduction in reliability of the memory device 200.

As described above, the time to enter the wait state WAIT is not limited to only any one time of the time points illustrated in FIGS. 2A to 2C. The wait state control unit 215 may be in the wait state WAIT a plurality of times before, during, and after the internal operation INOP is performed since the command CMD was received.

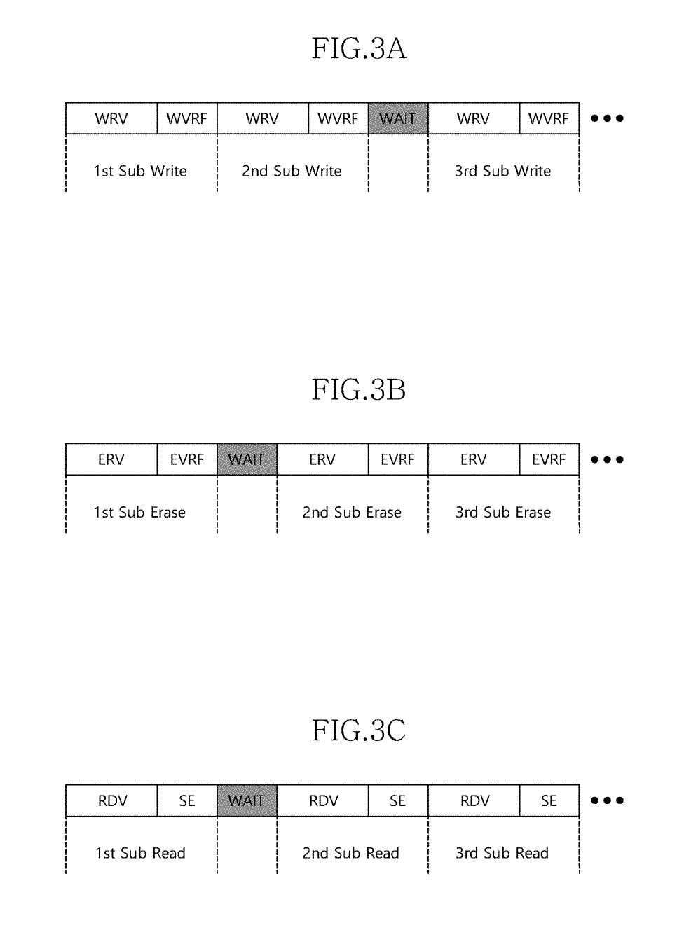

FIGS. 3A to 3C are diagrams for describing methods in which the wait state control unit 215 of FIG. 1 has the wait state WAIT while an internal operation is performed. FIGS. 3A to 3C illustrate methods in which the wait state control unit 215 has the wait state WAIT while a write operation, erase operation, and read operation are performed on the memory region 220, respectively.

Referring to FIG. 3A, the control unit 210 may repeat one or more sub write operations when performing a write operation on the memory region 220. FIG. 3A illustrates first to third sub write operations, for example. A single sub write operation may include a write voltage application operation WRV and a write verification operation WVRF. The write voltage application operation WRV may indicate an operation for applying a write voltage to memory cells. The write verification operation WVRF may indicate an operation for verifying whether desired data was written normally to memory cells by the write voltage. When a write success is obtained as a result of the write verification operation WVRF, the entire write operation may be ended. On the other hand, when a write fail is obtained as a result of the write verification operation WVRF, the control unit 210 may repeat a sub write operation using a higher write voltage. Such a write operation method is known as ISPP (Incremental Step Pulse Program).

As such, when a write operation includes one or more sub write operations, the wait state control unit 215 may be in the wait state WAIT depending on the internal temperature T_INT before a new sub write operation is repeated, that is, between consecutive sub write operations, according to the result of the write verification operation WVRF. For example, as illustrated in FIG. 3A, the wait state control unit 215 may be in the wait state WAIT depending on the internal temperature T_INT, before repeating the third sub write operation after the second sub write operation. However, the time between the second and third sub write operations is only provided as an example. Furthermore, the number of times that the wait state control unit 215 has the wait state WAIT during the write operation is not limited to one. For example, the wait state control unit 215 may be in the wait state WAIT depending on the internal temperature T_INT, immediately before each sub write operation is performed.

Referring to FIG. 3B, the control unit 210 may perform an erase operation in a manner similar to the write operation. Specifically, the control unit 210 may repeat one or more sub erase operations when performing the erase operation on the memory region 220. FIG. 3B illustrates first to third sub erase operations, for example. A single sub erase operation may include an erase voltage application operation ERV and an erase verification operation EVRF. The erase voltage application operation ERV may indicate an operation for applying an erase voltage to channels of memory cells. The erase verification operation EVRF may indicate an operation for verifying whether the memory cells were normally erased by the erase voltage. When an erase success is obtained as the result of the erase verification operation EVRF, the entire erase operation may end. On the other hand, when an erase failure is obtained as the result of the erase verification operation EVRF, the control unit 210 may repeat the sub erase operations using a higher erase voltage. Such an erase operation method is known as ISPE (Incremental Step Pulse Erase).

As such, when the erase operation includes one or more sub erase operations, the wait state control unit 215 may be in the wait state WAIT depending on the internal temperature T_INT before a new sub erase operation is performed, that is, between consecutive sub erase operations, according to the result of the erase verification operation EVRF. For example, as illustrated in FIG. 3B, the wait state control unit 215 may be in the wait state WAIT depending on the internal temperature T_INT, before the second sub erase operation is performed after the first sub erase operation. However, the time between the first and second sub erase operations is only provided as an example. Furthermore, the number of times that the wait state control unit 215 has the wait state WAIT during the erase operation is not limited to one. For example, the wait state control unit 215 may be in the wait state WAIT depending on the internal temperature T_INT, immediately before each sub erase operation is performed. Accordingly, the control unit 210 may perform a first erase voltage application operation ERV and a first erase verification operation EVRF in response to the command CMD and then the control unit 210 may be in the wait state WAIT depending on a result of the first erase verification operation EVRF before performing a second erase voltage application operation ERV and a second erase verification operation EVRF.

Referring to FIG. 3C, the control unit 210 may repeat one or more sub read operations when performing a read operation on the memory region 220. FIG. 3C illustrates first to third sub read operations, for example. A single sub read operation may include a read voltage application operation RDV and a sensing operation SE. The read voltage application operation RDV may indicate an operation for applying a read voltage to memory cells. The sensing operation SE may indicate an operation for sensing data read from memory cells by the read voltage. The sub read operations may be performed using different read voltages, and the control unit 210 may decide which data is stored in memory cells by combining data read through different read voltages. When each of the memory cells is a single-level cell for storing one bit of data, a read operation for the memory cell may use only one read voltage or include one sub read operation. When each of the memory cells is a multi-level cell for storing multiple bits, a read operation for the memory cell may use a plurality of different read voltages or include a plurality of sub read operations. Accordingly, the control unit 210 may perform a first read voltage application operation RDV and a first sensing operation SE in response to the command CMD and may then be in the wait state WAIT before performing a second read voltage application operation RDV and a second sensing operation SE.

As such, when the read operation includes one or more sub read operations, the wait state control unit 215 may be in the wait state WAIT depending on the internal temperature T_INT, before a new sub read operation is repeated, that is, between consecutive sub read operations. For example, as illustrated in FIG. 3C, the wait state control unit 215 may be in the wait state WAIT depending on the internal temperature T_INT, before the second sub read operation is repeated after the first sub read operation. However, the time between the first and second sub read operations is only provided as an example. Furthermore, the number of times that the wait state control unit 215 has the wait state WAIT during the read operation is not limited to one. For example, the wait state control unit 215 may be in the wait state WAIT depending on the internal temperature T_INT, immediately before each sub read operation is performed.

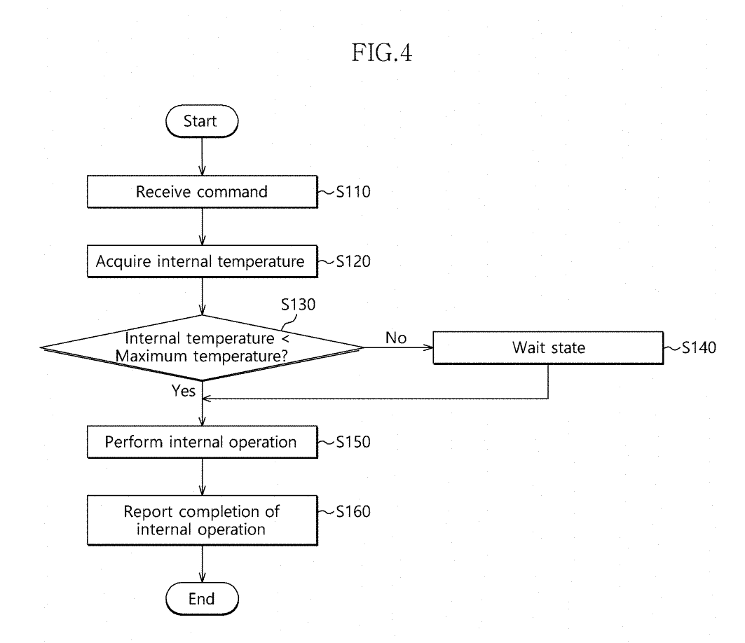

FIG. 4 is a flowchart illustrating an operating method of the memory device 200 of FIG. 1. FIG. 4 illustrates a method in which the wait state control unit 215 has a wait state before an internal operation is performed.

Referring to FIG. 4, the control unit 210 may receive a command from the controller 100 indicating an internal operation, at step S110.

At step S120, the wait state control unit 215 may acquire an internal temperature T_INT from the temperature sensor 230.

At step S130, the wait state control unit 215 may compare the internal temperature T_INT to the maximum temperature T_MAX. When the internal temperature T_INT is less than the maximum temperature T_MAX, the procedure may proceed to step S150. However, when the internal temperature T_INT is greater than or equal to the maximum temperature T_MAX, the procedure may proceed to step S140.

At step S140, the wait state control unit 215 may be in a wait state. That is, the wait state control unit 215 may be in the wait state before the internal operation corresponding to the command is performed. The wait state of step S140 may be maintained for a predetermined waiting time, for example.

At step S150, the control unit 210 may perform the internal operation corresponding to the command.

At step S160, the control unit 210 may report completion of the internal operation to the controller 100, when the internal operation is completed.

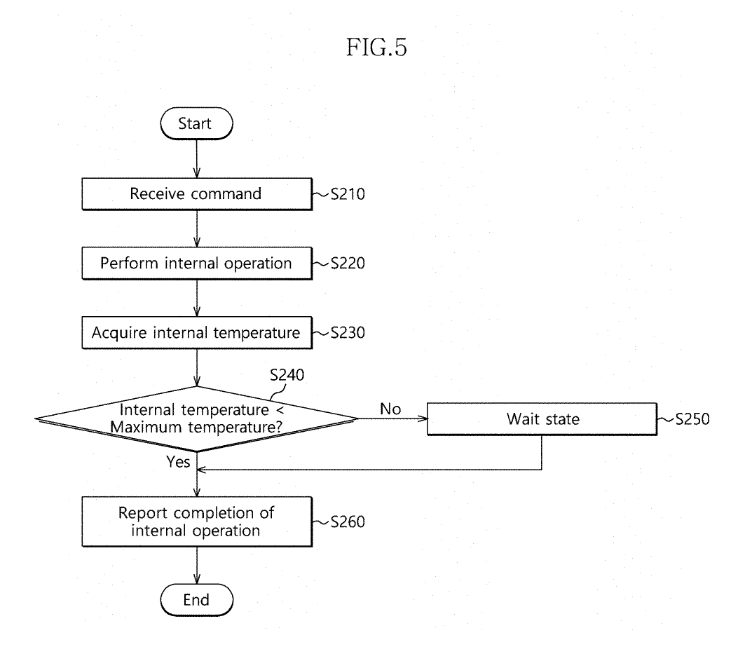

FIG. 5 is a flowchart illustrating an operating method of the memory device 200 of FIG. 1. FIG. 5 illustrates a method in which the wait state control unit 215 has a wait state after an internal operation is performed.

Referring to FIG. 5, the control unit 210 may receive a command from the controller 100 indicating an internal operation, at step S210.

At step S220, the control unit 210 may perform the internal operation corresponding to the command.

At step S230, the wait state control unit 215 may acquire an internal temperature T_INT from the temperature sensor 230.

At step S240, the wait state control unit 215 may compare the internal temperature T_INT to the maximum temperature T_MAX. When the internal temperature T_INT is less than the maximum temperature T_MAX, the procedure may proceed to step S260. However, when the internal temperature T_INT is greater than or equal to the maximum temperature T_MAX, the procedure may proceed to step S250.

At step S250, the wait state control unit 215 may be in a wait state. That is, the wait state control unit 215 may be in the wait state after the internal operation corresponding to the command was performed. The wait state of step S250 may be maintained for a predetermined waiting time, for example. The control unit 210 may delay reporting completion of the internal operation to the controller 100, when in the wait state.

At step S260, the control unit 210 may report the completion of the internal operation to the controller 100.

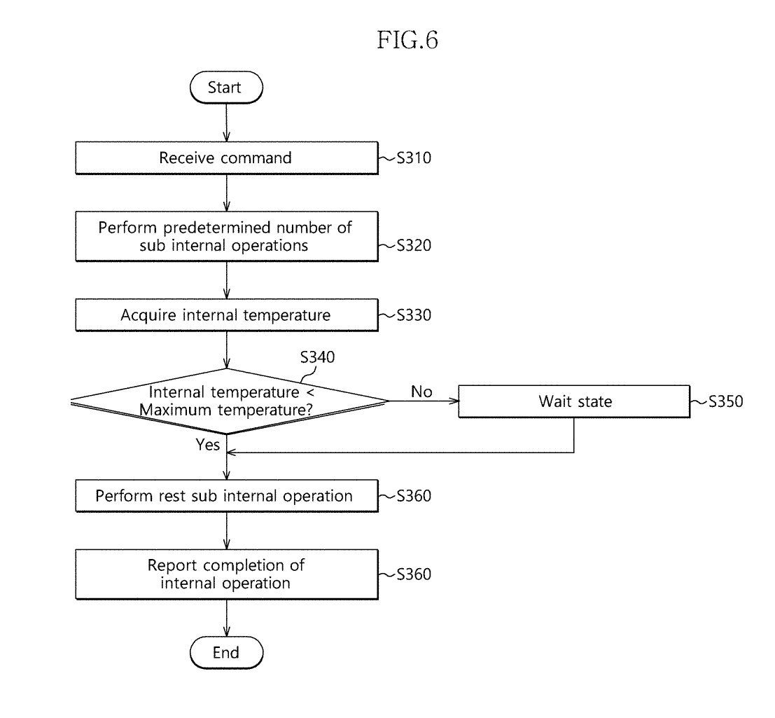

FIG. 6 is a flowchart illustrating an operating method of the memory device 200 of FIG. 1. FIG. 6 illustrates a method in which the wait state control unit 215 has a wait state while an internal operation is performed.

Referring to FIG. 6, the control unit 210 may receive a command from the controller 100 indicating an internal operation, at step S310. The internal operation indicated by the command may include a plurality of sub internal operations, for example.

At step S320, the control unit 210 may perform a predetermined number of sub internal operations as a part of the entire internal operation.

At step S330, the wait state control unit 215 may acquire an internal temperature T_INT from the temperature sensor 230.

At step S340, the wait state control unit 215 may compare the internal temperature T_INT to the maximum temperature T_MAX. When the internal temperature T_INT is less than the maximum temperature T_MAX, the procedure may proceed to step S360. However, when the internal temperature T_INT is greater than or equal to the maximum temperature T_MAX, the procedure may proceed to step S350.

At step S350, the wait state control unit 215 may be in a wait state. That is, the wait state control unit 215 may be in the wait state while the internal operation is performed. The wait state of step S250 may be maintained for a predetermined waiting time, for example.

At step S360, the control unit 210 may perform rest sub internal operations of the entire internal operation.

At step S370, the control unit 210 may report completion of the internal operation to the controller 100.

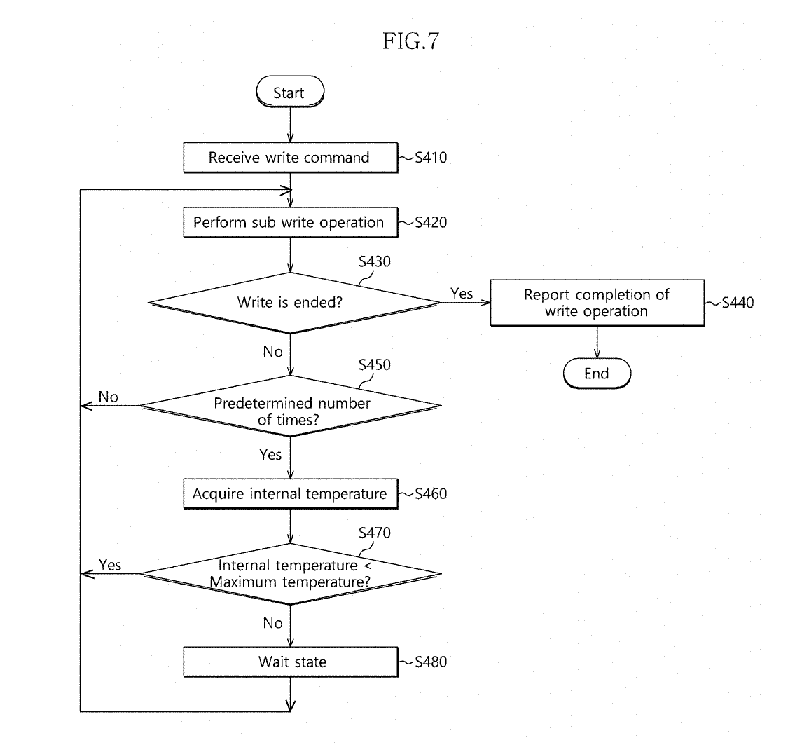

FIG. 7 is a flowchart illustrating an operating method of the memory device 200 of FIG. 1. FIG. 7 illustrates a method in which the wait state control unit 215 is in a wait state between consecutive sub write operations, when a write operation includes a plurality of sub write operations.

At step S410, the control unit 210 may receive a write command from the controller 100 indicating a write operation.

At step S420, the control unit 210 may perform a sub write operation in response to the write command. Specifically, the control unit 210 may perform a write voltage application operation and a write verification operation in response to the write command.

At step S430, the control unit 210 may determine whether to end the write operation depending on a result of the write verification operation. When the result of the write verification operation is a write success, the control unit 210 may determine to end the write operation, and the procedure may proceed to step S440.

At step S440, the control unit 210 may report completion of the write operation to the controller 100.

However, when the result of the write verification operation at step S430 is a write fail, the control unit 210 may determine not to end the write operation, and may proceed to step S450.

At step S450, the control unit 210 may determine whether the sub write operation was performed a predetermined number of times. If the sub write operation was performed the predetermined number of times, the procedure may proceed to step S460. If the sub write operation was not performed the predetermined number of times, the procedure may proceed to step S420. That is, the predetermined number of times may correspond to the number of times that the sub write operations in a wait state are repeated.

At step S460, the wait state control unit 215 may acquire an internal temperature T_INT from the temperature sensor 230.

At step S470, the wait state control unit 215 may compare the internal temperature T_INT to the maximum temperature T_MAX. If the internal temperature T_INT is less than the maximum temperature T_MAX, the procedure may proceed to step S420. However, if the internal temperature T_INT is greater than or equal to the maximum temperature T_MAX, the procedure may proceed to step S480.

At step S480, the wait state control unit 215 may be in the wait state. That is, the wait state control unit 215 may be in the wait state before a new sub write operation is repeated. The wait state of step S480 may be maintained for a predetermined waiting time, for example. When the wait state is ended, the procedure may proceed to step S420 to repeat a sub write operation. Thus, the wait state control unit 215 may be in the wait state WAIT depending on a result of the first write verification operation WVRF before performing a second write voltage application operation WRV and a second write verification operation WVRF.

As described with reference with FIGS. 3B and 3C, the erase operation including sub erase operations and the read operation including sub read operations may be performed in substantially the same manner as illustrated in FIG. 7.

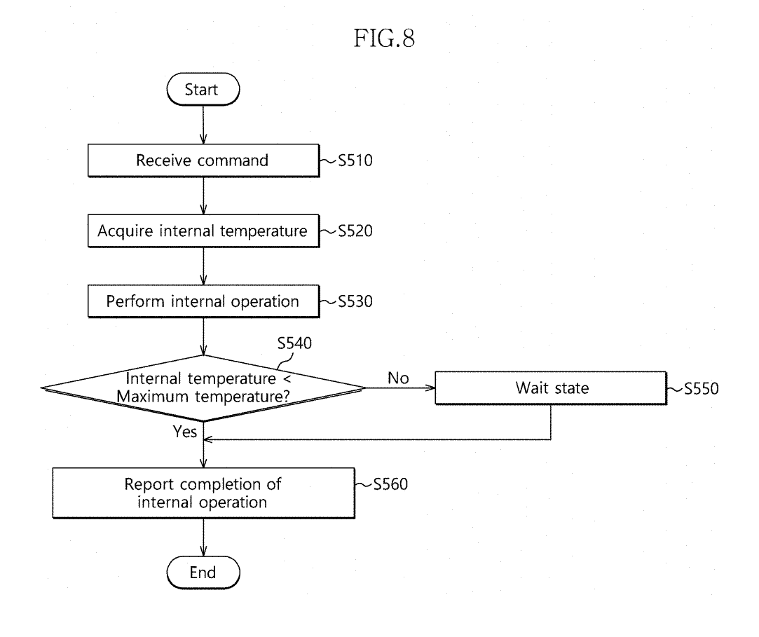

FIG. 8 is a flowchart illustrating an operating method of the memory device 200 of FIG. 1. FIG. 8 illustrates a method in which the wait state control unit 215 acquires an internal temperature before an internal operation is performed, and has a wait state depending on the acquired internal temperature after the internal operation is completed.

Referring to FIG. 8, the control unit 210 may receive a command from the controller 100 indicating an internal operation, at step S510.

At step S520, the wait state control unit 215 may acquire an internal temperature T_INT from the temperature sensor 230.

At step S530, the control unit 210 may perform the internal operation corresponding to the command.

At step S540, the wait state control unit 215 may compare the internal temperature T_INT to the maximum temperature T_MAX. When the internal temperature T_INT is less than the maximum temperature T_MAX, the procedure may proceed to step S560. However, when the internal temperature T_INT is greater than or equal to the maximum temperature T_MAX, the procedure may proceed to step S550.

At step S550, the wait state control unit 215 may be in the wait state. That is, depending on the internal temperature acquired before the internal operation was performed, the wait state control unit 215 may be in the wait state after the internal operation was performed. The wait state of step S550 may be maintained for a predetermined waiting time, for example.

At step S560, the control unit 210 may report a completion of the internal operation to the controller 100, when the internal operation is completed.

While various embodiments have been described above, it is will be understood to those skilled in the art that the embodiments described are examples only. Accordingly, the data storage device and the operating method thereof described herein should not be limited based on the described embodiments. Many other embodiments and or variations thereof may be envisaged by those skilled in the relevant art without departing from the spirit and or scope of the present disclosure as defined in the following claims.

What is claimed is:

1. A memory device comprising:
a memory region; and
a control unit suitable for performing an internal operation on the memory region in response to a command received from an external device, and in a wait state in connection with the performance of the internal operation, which depends on the internal operation.

2. The memory device of claim 1, wherein the control unit is in the wait state one or more of before, during, and after performing the internal operation in response to the received command.

3. The memory device of claim 1, wherein the control unit is in the wait state between consecutive sub internal operations included in the internal operation.

4. The memory device of claim 1, wherein the control unit performs a first write voltage application operation and first write verification operation in response to the command, and then is in the wait state depending on a result of the first write verification operation, before performing a second write voltage application operation and second write verification operation.

5. The memory device of claim 1, wherein the control unit performs a first read voltage application operation and first sensing operation in response to the command, and then is in the wait state before performing a second read voltage application operation and second sensing operation.

6. The memory device of claim 1, wherein the control unit performs a first erase voltage application operation and first erase verification operation in response to the command, and then is in the wait state depending on a result of the first erase verification operation, before performing a second erase voltage application operation and second erase verification operation.

7. The memory device of claim 1, wherein the control unit transmits a busy-state ready/busy signal to the external device, while in the wait state.

8. The memory device of claim 1, further comprising a temperature sensor,
wherein the control unit acquires the internal temperature from the temperature sensor and stores the acquired internal temperature before performing the internal operation, and is in the wait state depending on the stored internal temperature after performing at least part of the internal operation.

9. The memory device of claim 1, wherein the control unit compares the internal temperature and a maximum temperature set by the external device, and enters the wait state depending on the comparison result.

10. A memory device comprising:
a memory region; and
a control unit suitable for receiving a command for controlling the memory region from an external device, transmitting a busy-state ready/busy signal to the external device in response to the command, and having a wait state depending on an internal temperature,
wherein the control unit retains the ready/busy signal in the busy state while in the wait state.

11. The memory device of claim 10, wherein the control unit is in the wait state one or more of before, during, and after performing the internal operation in response to the received command.

12. The memory device of claim 10, wherein the control unit performs consecutive sub internal operations in response to the command, and is in the wait state between the sub internal operations.

13. The memory device of claim 10, wherein the control unit performs a first write voltage application operation and first write verification operation in response to the command, and then is in the wait state depending on a result of the first write verification operation, before performing a second write voltage application operation and second write verification operation.

14. The memory device of claim 10, wherein the control unit performs a first read voltage application operation and first sensing operation in response to the command, and then is in the wait state before performing a second read voltage application operation and second sensing operation.

15. The memory device of claim 10, wherein the control unit performs a first erase voltage application operation and first erase verification operation in response to the command, and then is in the wait state depending on a result of the first erase verification operation, before performing a second erase voltage application operation and second erase verification operation.

16. The memory device of claim 10, further comprising a temperature sensor,
wherein the control unit acquires the internal temperature from the temperature sensor and stores the acquired internal temperature before performing the internal operation corresponding to the command, and is in the wait state depending on the stored internal temperature after performing at least part of the internal operation.

17. The memory device of claim 10, wherein the control unit compares the internal temperature and a maximum temperature set by the external device, and enters the wait state depending on the comparison result.

18. A memory device comprising:
a memory region; and
a control unit suitable for performing an internal operation on the memory region in response to a command received from an external device, and delaying reporting a completion of the internal operation to the external device, depending on an internal operation.

19. The memory device of claim 18, wherein the control unit transmits a busy-state ready/busy signal to the external device, while delaying the reporting of the completion of the internal operation.

20. The memory device of claim 18, further comprising a temperature sensor,
wherein the control unit acquires the internal temperature from the temperature sensor and stores the acquired internal temperature before performing the internal operation, and has a wait state depending on the stored internal temperature after performing the internal operation.
